(19) United States
(12) Patent Application Publication
(10) Pub. No.: US 2005/0045454 A1
(43) Pub. Date: Mar. 3, 2005

(54) Detect swtich

(76) Inventor: Oceab H.R. Zhou, Hunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/928,325

(22) Filed: Aug. 27, 2004

(30) Foreign Application Priority Data
Aug. 27, 2003 (TW) 92215479

(51) Int. Cl. H01H 15/00

(52) U.S. Cl. 200/16 R

(57) ABSTRACT

A detect switch (100) includes a cover (2), a spring (3), a slider (4), a pair of movable contacts (5), a dielectric base (6) having a post (611), an actuator (7) and a number of fixed contacts (8). The cover (2) is formed from a planar metal sheet and is substantially rectangular and has a protrusion (20) projecting downwardly and defining a socket (21). The slider (4) defines an elongate trough (41) in an upper surface thereof for receiving the spring (3). The movable contacts (5) are mounted under the slider (4) and each have an arch-shaped configuration. The dielectric base (6) has a bottom wall (61) and a peripheral wall enclosing around the bottom wall (61), a post (611) projecting from the bottom wall (61) and a cutout (621) defined through the periphery wall. The actuator (7) comprises an upright columnar main body, a stopper arm (71), an actuating arm (72) and a guide camber (74).

### BACKGROUND OF THE INVENTION

1. Field of the Invention

The present invention relates to a switch, and particularly to a switch for detection.

2. Description of Related Art

A conventional structure of a detect switch are shown in FIGS. 7 and 8, wherein FIG. 7 is an exploded view of the conventional switch, and FIG. 8 is a proportion exploded view thereof.

As is shown in those figures, the conventional detect switch 100′ usually includes a dielectric base 6′ defining a lower concave 61′ through a bottom wall thereof, a first cover 2′ engaging with the dielectric base 6′, a second cover 9′ positioned between the dielectric base 6′ and the first cover 2′, a plurality of fixed contacts 8′ mounted under the bottom wall of the dielectric base 6′, a pair of movable contacts 5′ positioned on an inner surface of the bottom wall and located corresponding to the plurality of fixed contacts, a slider 4′ positioned on the movable contacts 5′ movable driving the movable contacts 5′, a spring 3′ received in the slider 4′ and an actuator 7′. The second cover 9′ comprises a downwardly projecting nut. The nut defines an upper concave 91′ corresponding to the lower concave 61′. The actuator 7′ forms integrally an actuator arm 71′ and a pair of hold portions 70′. The hold portions 70′ comprise an upper column and a lower column extending into the corresponding upper concave 91′ and lower concave 61′. In assembly, the upper and lower columns respectively engage for the upper concave 91′ and the lower concave 61′. In operation, the actuator 7′ is triggered and pivots on the hold portions 70′. The actuator arm 71′ in turn drives the slider 4′ and places the movable contacts 5′ in different places. In this way, the movable contacts 5′ can connect with the fixed contacts 8′ in different manners and achieve the purpose of the switch.

However, if the second cover 9′ cannot be securely retained between the first cover 1′ and the dielectric base 6′, the second cover 9′ tends to move relative to base 6′. Therefore, the upper concave 91′ and the lower concave 61′ cannot steadily fix the upper and lower columns therein, the actuator 7′ tends to shiver in top-to-bottom directions. As a result, the actuator 7′ easily disengages from the upper concave 91′ and the lower concave 61′ during operation. In another hand, the conventional switch has to additionally need a lower cover to defining the concave 91′, resulting in a complex configuration.

### BRIEF SUMMARY OF THE INVENTIN

A primary object of the present invention is to provide a simple switch having an actuator securely retained therein.

To achieve the object, a simple switch comprising: a cover, a spring, a slider, a pair of movable contacts, a dielectric base having a post, an actuator and a number of fixed contacts. The cover is formed from a planar metal sheet and is a substantially rectangular and has a protrusion downwardly projecting therefrom. The protrusion of the cover defines a socket for engaging with a post of the dielectric base. The slider defines an elongate trough in an upper surface thereof for receiving the spring. The movable contacts are mounted under the slider and each have an arch-shaped configuration. The dielectric base has a bottom wall and a periphery wall enclosing around the bottom wall, the post projecting from the bottom wall, a cutout being defined through the periphery wall. The actuator comprises an upright columnar main body, a stopper arm, a actuating arm and a guide camber.

To compare with the present technology, the merit of this invention is the post which the actuator coupled with. And the post is integrated with the dielectric base. In assembly, the actuator couples with the post, which can avoids the shave and prevents mistakes of placing. In another hand, this invention can reduce a cover, and the configuration may be simpler comparing with the present technology.

### BRIEF DESCRIPTION OF THE DRAWINGS

FIG. 1 is a perspective view of a switch in accordance with the present invention;

FIG. 2 is an exploded view of the switch of FIG. 1;

FIG. 3 is a partially assembled view of FIG. 2;

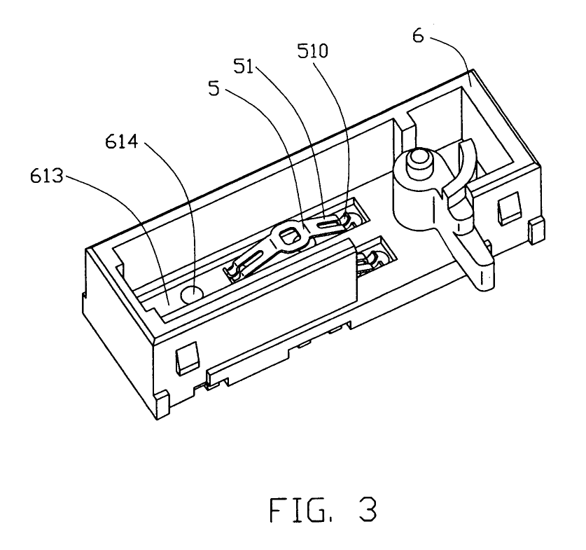

FIG. 4 is a similar view of the FIG. 1, but removing a cover for clarity;

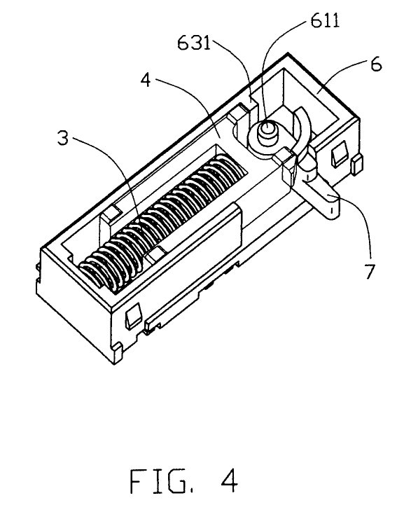

FIG. 5 is a perspective view of a slider of the switch of the FIG. 1, showing the bottom surface of the slider;

FIG. 6 is a perspective view of a cover of the switch of the FIG. 1 showing the bottom surface thereof;

FIG. 7 is an exploded view of a conventional switch; and

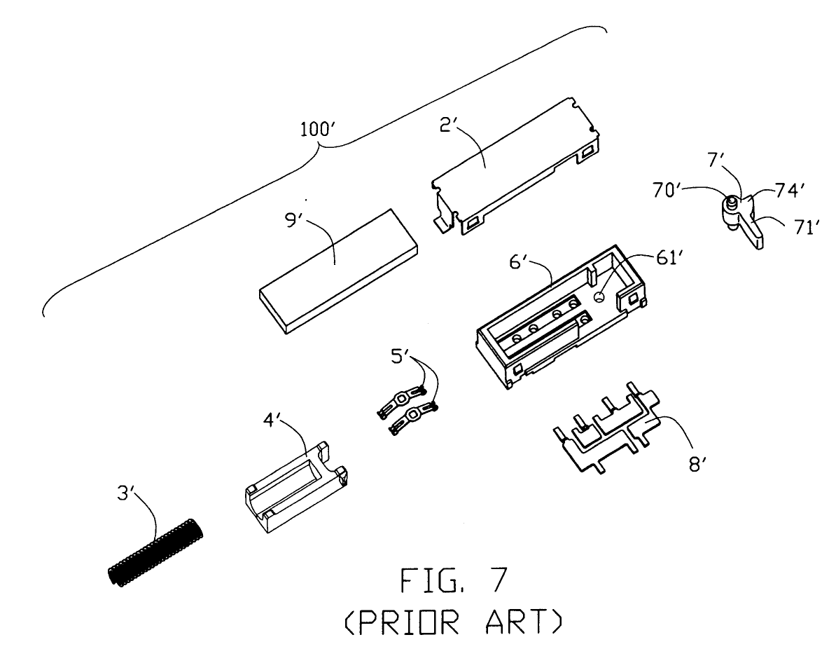

FIG. 8 is a perspective view of a lower cover of the conventional switch of FIG. 7.

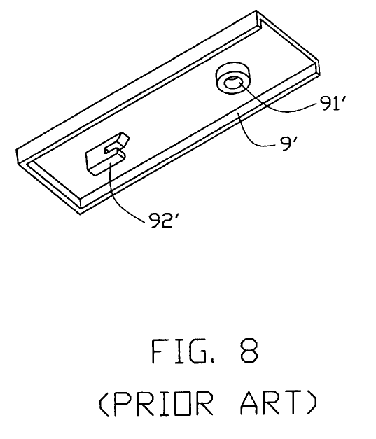

### DETAILED DESCRIPTION OF THE INVENTION

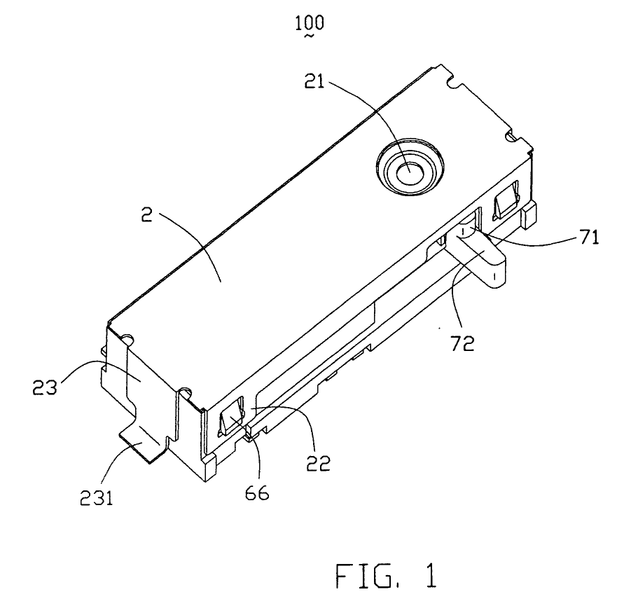

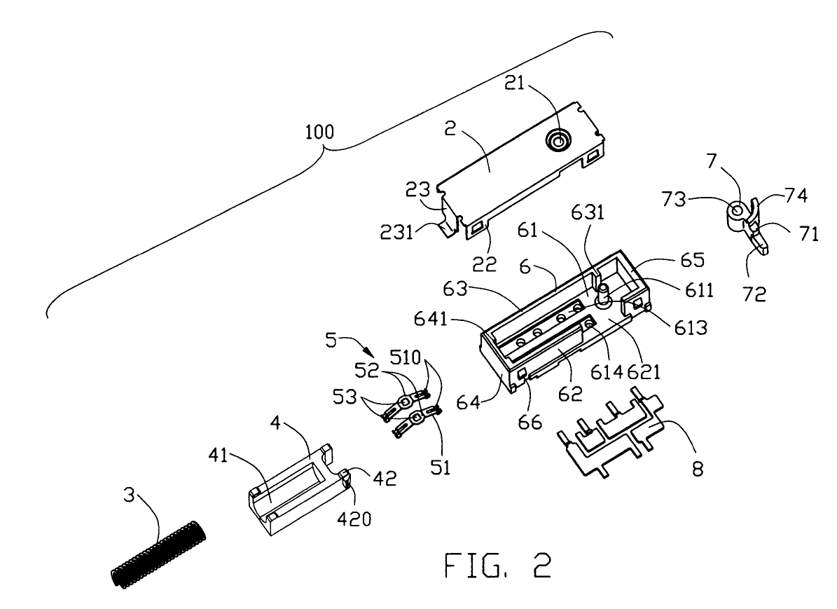

Referring to FIGS. 1 and 2, a detect switch comprises a cover 2, a spring 3, a slider 4, a pair of movable contacts 5, a dielectric base 6 having a post 611, an actuator 7 and a plurality of fixed contacts 8.

The dielectric base 6 has a substantially rectangular configuration and comprises a bottom wall 61. A periphery wall extends upwardly and encloses around the bottom wall 61. The periphery wall comprises opposite front and rear walls 62 and 63 and opposite left and right sidewalls 64 and 65. A post 611 upwardly projects from the bottom wall 61 and is adjacent to the right sidewall 65. A pair of elongate grooves 613 is defined in an inner surface of the bottom wall 61 and extends from the left sidewall 64 toward the post 611. The grooves 613 are parallel to the front and rear walls 62 and 63. Two rows of contacting holes 614 are defined through the bottom wall 61 and are communicate with corresponding grooves 613. A stopper wall 631 forwardly projects from the rear wall 63 toward the post 611. A plurality of fixing projections 66 project from outer surfaces of the front and rear walls 64 and 65. A concave 641 is defined in the left wall 64.

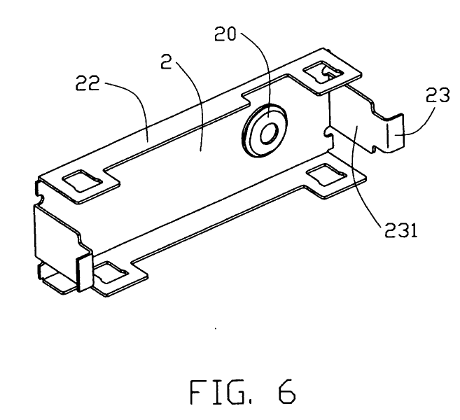

Also referring to FIGS. 2 and 6, the cover 2 is formed from a planar metal sheet and is a substantially rectangular. The cover 2 comprises a protrusion 20 downwardly projecting therefrom. The protrusion 20 is arranged corresponding to post 611 and defines a socket 21 in a lower surface thereof for engaging with a top end of the post 611. A plurality of tabs 22 extends downwardly from opposite front and rear edges of the cover 2. Each tab 22 defines a fixing hole (not labeled) for engaging with a corresponding fixing projection 66. A pair of legs 23 extends downwardly from opposite side edges of the cover 2 and each comprise a foot 231 outwardly and horizontally extending from a lower end thereof.

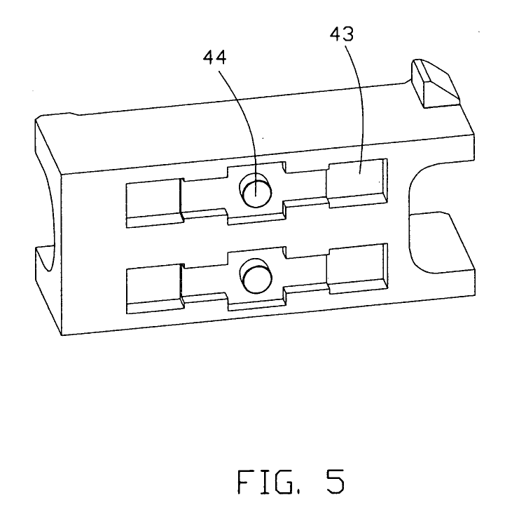

Referring to FIGS. 2 and 5, the slider 4 is substantially cubic and is received in the dielectric base 6. The slider 4 defines an elongate trough 41 in an upper surface thereof for receiving the spring 3. The trough 41 extends through a left surface of the slider 4 and is parallel to the front and rear walls 62 and 63. A pair of arms 42 projects rightward from a right end of the slider 4. A projection 420 forwardly projects from one of the arms 42. A pair of elongate recesses 43 are defined in a bottom surface of the slider 4 and are arranged corresponding to the grooves 63. A pair of holding poles 44 is formed in corresponding recesses 43 and project downwardly beyond the recesses 43.

The movable contacts 5 are mounted under the slider 4 and each have an arch-shaped configuration. Each contact 5 comprises a central rectangular holding portion 52. The holding portion 52 defines a holding opening 53 therethrough for engaging with a corresponding holding pole 44. Two pairs of bifurcate contact finger 51 extend from opposite sides of the holding 52, respectively. The contact fingers 51 are substantially parallel and each has a convex contact portion 510 downwardly extending from a distal end thereof.

Referring to FIG. 2, the actuator 7 comprises an upright columnar main body, a stopper arm 71, an actuating arm 72 and a guide camber 74. The columnar main body defines a through hole 73. The through hole 73 is cylindrical and is concentric and is concentric with the main body. The stopper arm 71 is built on the actuating arm 72. The guiding camber 74 extends from the stopper arm and the actuating arm 71 and 72 and partially circles around the main body. The guiding camber 74 is a small segment of a cylinder and has the same central axis as the main body.

In assembly, the fixed contacts 8 are mounted a lower surface of the bottom wall 61 with contacting ends exposed upwardly through the contacting holes 614. The through hole 73 of the actuator 7 engages with the post 611 with a top end of the post 611 upwardly extending beyond the through hole 73. The actuating arm 72 extends beyond the front wall 62 of the base 6 through the cutout 621 and abuts against the front wall 62 of the base 6. The guiding camber 74 has an outer periphery abutting against the front wall 62. The holding openings 53 of the movable contacts 5 engage with the corresponding holding poles 44. The slider 4 holding the movable contacts 5 is mounted on the bottom wall 61 of the dielectric base 6 with the arms 42 respectively abutting against the stopper wall 631 and the actuating arm 72. The contacts 5 are positioned in corresponding grooves 613 with the convex portions 510 extending through selected contacting holes 64 to contact with selected fixed contacts 8. The spring 3 is elastically compressed with opposite ends respectively abutting against the slider 4 and the recess 641 of the base 6.

As the post 61 is integrated with the dielectric base 6, the actuator 7 can remain still with the post 61 in operation and can be prevented from shaving, which may lead to mistakes of placing. The slider 4 abuts the stopper wall 631, and the spring 3 is constricted as a normal status.

In operation, the actuator 7 is trigged and pivots on the post 61, which in turn push the slider 4 to move away from the stopper wall 631 until the projection 420 abuts a left side of the cutout 621 of the front wall 62 of the dielectric base 6. How far the slider 4 moves is determined by angle that the actuator 7 pivots. Being mounted with the slider 4, the contacts 5 are movable with the slider 4. The different place of the movable contacts 5, which is droved by the slider 4 and determined by the press acting on the actuator 7, results in different electric statuses. One end of the spring 3 is caught in the recess 641 and the main body of the spring 3 is embodied in the trough 41. If released, the spring 3 restores to its normal position, which in turn forces the slider 4 to restore until the arm 42 abuts the stopper wall 631.

It will be understood that the invention may be embodied in other specific forms without departing from the spirit or central characteristics thereof. The present examples and embodiments, therefore, are to be considered in all respects as illustrative and not restrictive, and the invention is not be limited to the details given herein.

1. A detect switch comprising:
a dielectric base having a bottom wall and a peripheral wall enclosing around the bottom wall, a post projecting from the bottom wall and a cutout being defined through the peripheral wall;
a plurality of fixing contacts mounted on the bottom wall of the base;
a cover engaging with said dielectric base and comprising a protrusion engaging with the said post;
a spring;
an actuator having a main body and an actuating arm extending from the main body, the main body defining a through hole engaging with said post, the actuating arm outwardly extending through the cutout of the base;
a pair of movable contacts, each movable contact comprising a holding portion and a contact portion extending toward the bottom wall for electrically connecting with one of the fixing contacts; and
a slider movably mounted on the bottom wall of the dielectric base and actuatable by the actuator, the slider holding the holding portion of the movable contact on a bottom surface thereof, the slider comprising an end abutting against the actuator, the slider defining a trough receiving the spring therein.

2. The detect switch as claimed in claim 1, wherein the protrusion of the cover defines a socket for engaging with the post of the dielectric base.

3. The detect switch as claimed in claim 1, wherein said actuating arm comprises a stopper arm and a longer arm and said stopper arm is built on said longer one, said stopper arm and said longer arm exerting actuator force on the slider.

4. The detect switch as claimed in claim 1, wherein said fixed contacts comprise a plurality of independent contacts.

5. The detect switch as claimed in claim 1, wherein said bottom wall has an elongate groove defined therein, said movable contacts moving along said groove.

6. The detect switch as claimed in claim 5, wherein the bottom wall defines a plurality of contacting holes.

7. The detect switch as claimed in claim 6, wherein said movable contacts are parallel to each other, said contact portions being formed at distal ends thereof, said contact portions contacting with said fixed contacts through said contacting holes.

8. A detect switch comprising:
a dielectric base and a conductive cover fixed to the base;
a plurality of fixing contacts and a plurality of moveable contacts disposed in the base;
a slider linearly moveable in the base to move the movable contacts for engagement with the corresponding fixing contact;
a pivotal actuator rotatably moveable in the base beside said slider to move the slider; wherein
a pivot axis of said pivotal actuator defines two opposite ends both of which are engaged with the base and the cover, respectively.
